(19) United States
(12) Patent Application Publication
(10) Pub. No.: US 2014/0360374 A1
(43) Pub. Date: Dec. 11, 2014

(54) Odor and Moisture Controller

(71) Applicant: Roc Hatfield, Safety Harbor, FL (US)

(72) Inventor: Roc Hatfield, Safety Harbor, FL (US)

(73) Assignee: N1 TECHNOLOGIES INC., Safety Harbor, FL (US)

(21) Appl. No.: 14/296,083

(22) Filed: Jun. 4, 2014

Related U.S. Application Data
(60) Provisional application No. 61/831,464, filed on Jun. 5, 2013.

(51) Int. Cl. B01D 53/04

(52) U.S. Cl. CPC B01D 53/0415
USPC 96/108

(57) ABSTRACT

An odor and moisture controller is provided as a means of reducing or limiting unwanted moisture and odors within a refrigerator or food storage container. The odor and moisture controller is particularly suited for the removal of gaseous ethylene from a refrigerator or food storage container. The odor and moisture controller is able to remove ethylene gas through the use of a naturally active absorbent formulation. The absorbent formulation is retained within a pouch to allow aeration and positioned within a cross-ventilated container. The cross ventilated container is placed within a refrigerator or food storage container and prevents the pouch from directly contacting damp surfaces. The cross ventilated container permits airflow to reach to the absorbent formulation facilitating the removal of unwanted gases from the air within the refrigerator or food storage container.

The current application claims a priority to the U.S. Provisional Patent application Ser. No. 61/831,464 filed on Jun. 5, 2013.

### FIELD OF THE INVENTION

The present invention generally relates to an apparatus for a humidity and odor controller. More specifically, to an apparatus for a humidity and odor controller for use with a refrigerator that removes ethylene gas which eliminates odors and makes food last longer.

### BACKGROUND OF THE INVENTION

When storing food in a refrigerator, food releases ethylene gas which causes unpleasant odors and accelerates the ripening or decaying process. Current products on the market attempt to create a seal around foods to prevent the spread of ethylene gas. while these products, such as Green Bags and plastic sealing containers, attempt to address the problem by containing the ethylene gas, they accelerate the ripening and decaying process for the sealed fruit or vegetable sealed within in the container. Other products on the market attempt to eliminate ethylene gas as well as odor causing gasses. However, these products glaze over after a few days and are rendered ineffective due to oversaturation.

One of the products that attempts to eliminate they gas is Baking soda. Currently baking soda, sodium bicarbonate, is considered the only product on the market that manages ethylene gas. Baking soda is an amphoteric compound that reacts well with both acids and bases but can also bind with uncharged compounds such as ethylene. Although baking soda has impressive properties, it is ineffective for the removal of ethylene gas from a refrigerator or food storage container. In a refrigerator or food storage container, baking soda preferentially binds with acids and bases over short chain hydrocarbons such as ethylene. As a result, ethylene can build up within a refrigerator and food storage container. Another disadvantage of baking soda is caused by the formation of an impermeable layer of neutralized product. This impermeable layer significantly reduces the effectiveness of the baking soda by inhibiting unwanted gases from binding with baking soda.

It is therefore the object of the present invention to provide an odor and moisture controller for use in a refrigerator or food storage container. The odor and moisture controller is particularly suited for the removal of gaseous ethylene from a refrigerator or food storage container. The odor and moisture controller accomplishes this through the use of a cross-ventilated container and a pouch containing a naturally active absorbent formulation. The cross ventilated container optimizes the airflow to the absorbent pouch. The absorbent formational is particularly suited for the removal of ethylene gas through a combination of absorptive and adsorptive properties.

### BRIEF DESCRIPTIONS OF THE DRAWINGS

FIG. 1 is a perspective view displaying the odor and moisture controller as per the current embodiment of the present invention.

FIG. 2 is a perspective view displaying the absorbent pouch removed from the enclosure as per the current embodiment of the present invention.

FIG. 3 is a cross sectional view displaying the interior chamber of the enclosure and internal composition of the absorbent pouch.

FIG. 4 is a cross sectional view displaying the cross ventilated passage of airflow through the interior chamber by way of the plurality of vents as per the current embodiment of the present invention.

### DETAIL DESCRIPTIONS OF THE INVENTION

All illustrations of the drawings are for the purpose of describing selected versions of the present invention and are not intended to limit the scope of the present invention.

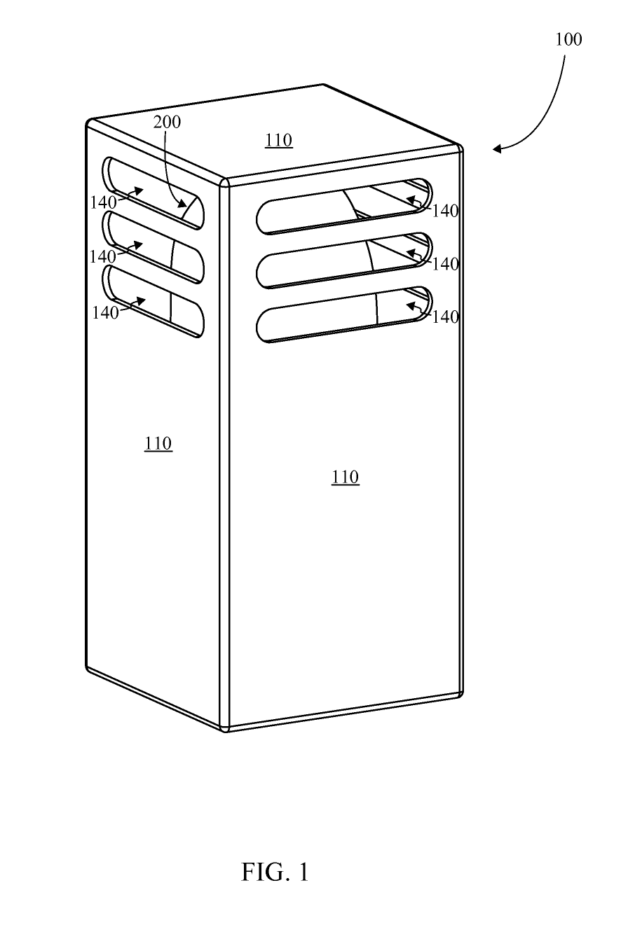

Referencing FIG. 1-4, the present invention is an odor and moisture controller for use in a refrigerator or food storage container. The odor and moisture controller is particularly suited for the removal of gaseous ethylene from a refrigerator or food storage container. In the current embodiment of the present invention, the odor controller comprises an enclosure 100 and an absorbent pouch 200. The enclosure 100 is a protective housing that prevents the absorbent pouch 200 from directly contacting those surfaces within a refrigerator or food storage container. The absorbent pouch 200 is positioned within the enclosure 100 and serves as the means of removing gaseous ethylene from a refrigerator or food storage container.

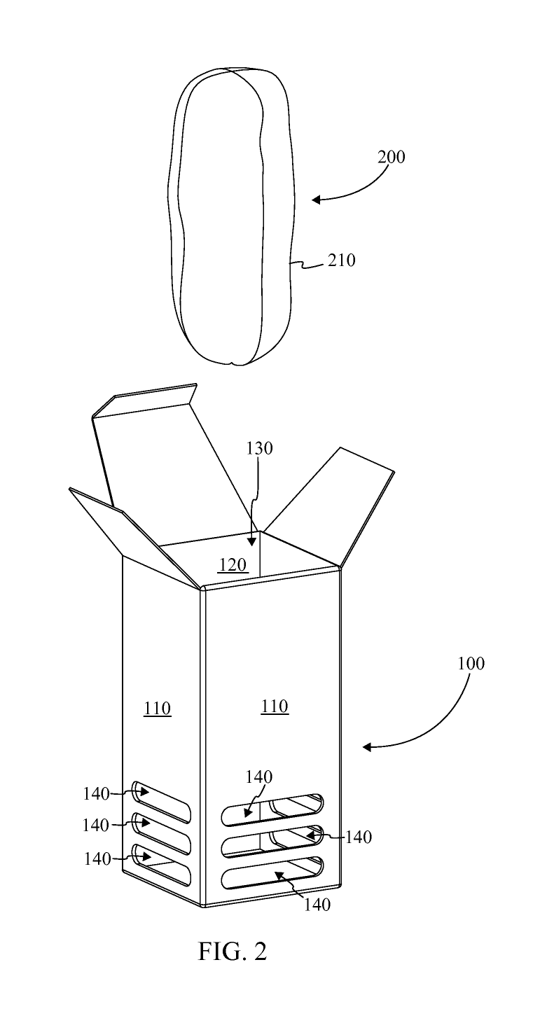

Referencing FIG. 1 and FIG. 2, the enclosure 100 serves as a protective barrier for the absorbent pouch 200. The enclosure 100 prevents the absorbent pouch 200 from directly contacting surfaces within a refrigerator or food storage container. The absorbent pouch 200 is removeably positioned within the absorbent pouch 200 permitting an installed absorbent pouch 200 to be replaced if needed. In the current embodiment of the present invention, the enclosure 100 comprises outer walls 110, an interior chamber 120, at least one opening 130, and a plurality of vents 140. The outer walls 110 serve as the exterior of the enclosure 100 that surrounds the interior chamber 120. The interior chamber 120 is the formed space that holds the absorbent pouch 200. The at least one opening 130 is a sealable passage way that permits access into the interior chamber 120. The at least one opening 130 serves as the means of installing or removing the absorbent pouch 200 from within the interior chamber 120. The plurality of vents 140 traverse into the interior chamber 120 through the outer walls 110 exposing the absorbent pouch 200 to gases within a refrigerator or food storage container.

The outer walls 110 serve as the exterior portion of the enclosure 100. Referencing FIG. 1 and FIG. 1-3, the enclosure 100 is provided as a hollow rectangular cube. In the cube configuration, the outer walls 110 consist of the lateral walls and the oppositely positioned face sides that make up the cube. The outer walls 110 serve as a protective barrier that separates the absorbent pouch 200 from surfaces within a refrigerator or food storage container. The outer walls 110 limit moisture from interacting with the absorbent pouch 200. The outer walls 110 are provided with some amount of moisture resistance provided by its material construction. The outer walls 110 can be constructed from a plurality of materials that include but are not limited to plastics, polymers, metals, ceramics, and paper products.

Referencing FIG. 2-4, the interior chamber 120 is the voided space formed by the outer walls 110. The volume of the interior chamber 120 is particularly sized to accommodate the absorbent pouch 200 while leaving sufficient space to aerate the contents of the absorbent pouch 200. The interior chamber 120 is accessible through the at least one opening 130. The absorbent pouch 200 is positioned within the interior chamber 120 through the at least one opening 130. The plurality of vents 140 provide airflow into the interior chamber 120.

The at least one opening 130 is provided as a sealable passage way for accessing the interior chamber 120. Referencing FIG. 2, the at least one opening 130 is sealed through the use of a set of folding flaps joined to the outer wall. The set of folding flaps are disengaged providing the at least one opening 130 as uncovered and the interior chamber 120 as accessible. It should be noted that the means of sealing the at least one opening 130 may vary as needed and that configurations of the present invention utilizing more than one opening 130 may use differing means for sealing each individual opening.

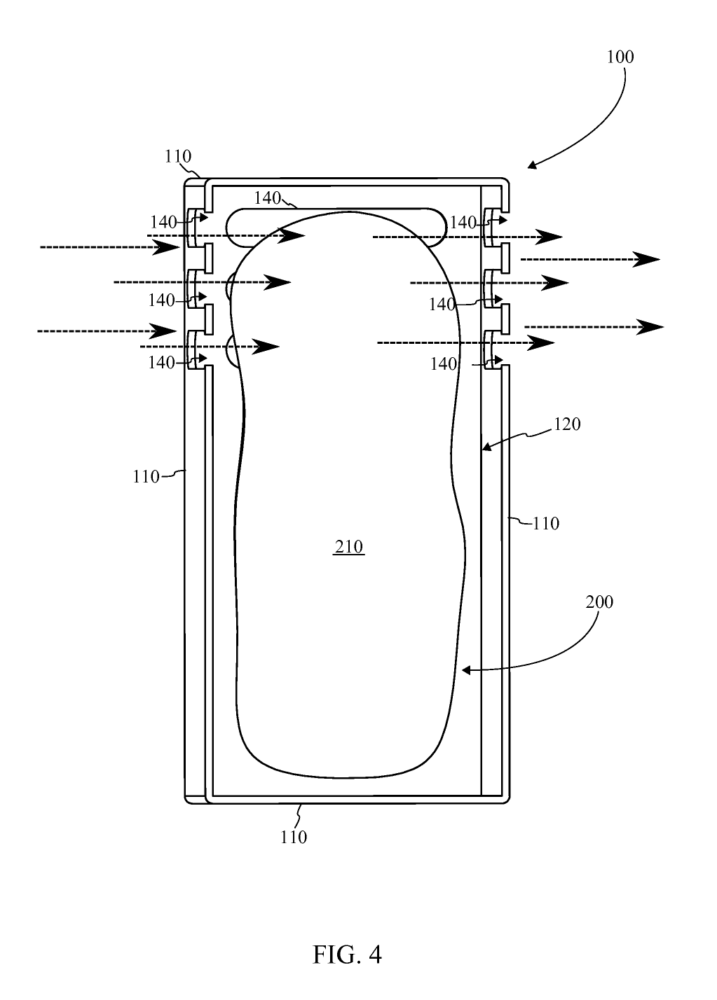

Referencing FIG. 4, the plurality of vents 140 function as airflow passageways into the interior chamber 120. The plurality of vents 140 traverse through the outer wall and into the interior chamber 120. Referencing FIG. 1 and FIG. 2, the plurality of vents 140 are positioned of the lateral face sides of the enclosure 100 as an array of vents 140 arranged in a linear pattern. The quantity of vents 140 utilized on an enclosure 100 are dependent on the airflow required to enable the present invention to effectively function.

Referencing FIG. 2-4, the absorbent pouch 200 is the odor and moisture reducing component positioned within the interior chamber 120. The absorbent pouch 200 is particularly formulated to mitigate odor and moisture within a refrigerator or food storage container by removing moisture and odor causing compounds from the air. The plurality of vents 140 provide airflow into the interior chamber 120 enabling the absorbent pouch 200 to remove unwanted gaseous compounds and moisture. In the current embodiment of the present invention, the absorbent pouch 200 comprises a permeable exterior 210 and an absorbent formulation 220. The permeable exterior 210 is provided as an air permeable container that holds the absorbent formulation 220. The absorbent formulation 220 is reactive to ambient moisture and unwanted gaseous compounds.

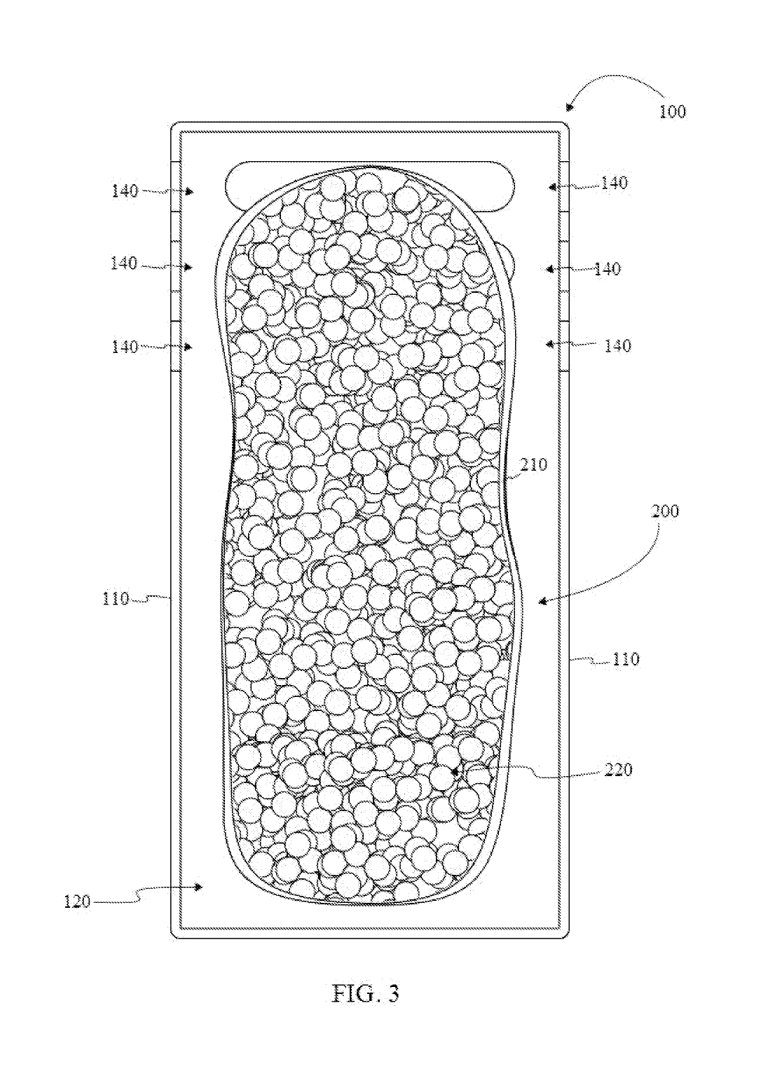

Referencing FIG. 2 and FIG. 3, the permeable exterior 210 is an air permeable container that holds the absorbent formulation 220 within its walls. The permeable exterior 210 retains the absorbent formulation 220 in place without significantly hindering air flow to the absorbent formulation 220. In the current embodiment of the present invention, the permeable exterior 210 is constructed of a pliable and permeable material. The permeable exterior 210 can be accomplished by a plurality of materials that include but are not limited to non synthetic materials such as canvas or cloth, synthetic materials such as nylon or polyester, and combinations thereof. It should be noted that the permeable exterior 210 may be accomplished by more rigid materials provided the construction of the permeable exterior 210 does not significantly restrict the air flow to the absorbent formulation 220.

Referencing FIG. 2, the absorbent formulation 220 is the active component that removes moisture and unwanted gases from within a refrigerator or food storage container. In the current embodiment of the present invention, the absorbent formulation 220 comprises an absorbent clay. The absorbent clay is a mixture of various naturally occurring minerals and compounds with particular properties that enable binding or absorption of moisture and certain gaseous compounds. The absorbent clay is provided as a plurality of pellets that increase the surface area of the absorbent clay. In the current embodiment of the present invention, each pellet of the plurality of absorbent clay pellets is approximately 4.0 mm in diameters. The 4.0 mm diameter size of each absorbent clay pellets facilitates movement and placement of the absorbent pouch 200 within the interior chamber 120.

In the current embodiment of the present invention, the absorbent clay comprises at least one naturally active mineral. The naturally active minerals comprise a wide range of aluminium silicates and phyllosilicate that are commonly referred to as fuller's earth clays. Fuller's earth clays are composite clay like substances with particular properties for absorbing or removing a wide range of organic and inorganic compounds from liquid and gases without chemical alteration. The naturally active mineral is selected from a group of naturally occurring clays consisting of Palygorskite, Sepiolite, Montmorillonite, Beidellite, and Kaolinite.

TABLE 1
Naturally Active Minerals

| Minerals | Composition | Formula |
|---|---|---|
| Palygorskite | Magnesium Aluminium | (Mg,Al)₂Si₄O₁₀(OH)•4(H₂O) |
| | Phyllosilicate | |
| Sepiolite | Magnesium Phyllosilicate | Mg₄Si₆O₁₅(OH)₂•6H₂O |
| Montmorillonite | Hydrated Sodium Calcium | (Na,Ca)_{0.33}(Al,Mg)₂(Si₄O₁₀)(OH)₂•nH₂O |
| | Aluminium Magnesium | |
| | Silicate Hydroxide | |
| Beidellite | Hydrated Sodium Calcium | Na_{0.5}Al_{2.5}Si_{3.5}O₁₀(OH)₂•(H₂O) |
| | Aluminium Magnesium | |
| | Silicate Hydroxide | |
| Kaolinite | Aluminum Silicate | (Al₂Si₂O₅(OH)₄) |
| | Hydroxide | |

Palygorskite, commonly referred to as attapulgite, is a magnesium aluminium phyllosilicate clay that naturally occurs throughout the world. Palygorskite clays have absorptive and adsorptive properties imparted by structural geometry and by the attractive forces of the oxygen atoms of silicate (SO₄). Palygorskite forms two dimensional tetrahedral sheets of silicate. The oxygen atoms of silicate serve as sorption sites. When the two dimensional tetrahedral silicate sheets combine, a fibrous and porous material is formed with physico-chemical attractive properties.

Sepiolite is a magnesium phyllosilicate clay that naturally occurs throughout the world. Sepiolite is similar to Palygorskite but contains a lower quantity of aluminium if at all present. Like Palygorskite, Sepiolite forms two dimensional tetrahedral sheets of silicate. The oxygen atoms of silicate serve as sorption sites. As a result, Sepiolite is shares similar physico-chemical attractive properties with Palygorskite.

Montmorillonite is an absorbent aluminium phyllosilicate clay that is naturally found throughout the world and is commonly classified as a Bentonite clay. Specifically Montmorillonite is a hydrated sodium calcium aluminium magnesium silicate hydroxide with sorptive properties (adsorptive and absorptive) imparted by its structural geometry and attractive forces of its various constituent groups. Montmorillonite belongs to the smectite group of phyllosilicate minerals which form two tetrahedral silicate sheets positioned across an octahedral sheet which carries 50% of its charged constituents. As a result, Montmorillonite forms a soft and porous material with strong electro-chemical attractive properties.

Beidellite is an absorbent aluminium phyllosilicate clay that is naturally found throughout the world. Similar to Montmorillonite, Beidellite is a hydrated sodium calcium aluminium magnesium silicate hydroxide and shares similar sorptive properties. Beidellite belongs to the smectite group of phyllosilicate minerals but differs from Montmorillonite, by carrying 50% of its charged constituents on the tetrahedral silicate sheets instead of the octahedral sheets. While similar, Beidellite has slightly different electro-chemical attractive properties from Montmorillonite.

Kaolinite is an aluminum silicate hydroxide clay mineral that is found throughout the world. Kaolinite comprises tetrahedral silicate sheets that are linked to octahedral alumina sheets through an oxygen atom. Kaolinite is relatively inert but illicit adsorptive properties when partially hydrated.

Through the use of at least one naturally active mineral, the present invention was experimentally determined to reduce the amount of ethylene gas and unwanted moisture within a refrigerator or food storage container principally due to their sorptive properties.

It should be noted that absorbent clay may comprise any combination of the aforementioned naturally active minerals and that additional embodiments may include non-naturally occurring compounds to enhance the functionality of the absorbent formulation 220.

TABLE 2
Absorbent Formulation

| Compounds | % Volume (v/v) of Formulation |
|---|---|
| Absorbent Clay | 50.0 to 100% (v/v) |
| Activated Carbon | 0.1 to 50.0% (v/v) |

In an additional embodiment of the invention, the absorbent formulation 220 additionally comprises activated carbon. Activated carbon is a processed form of carbon that has a high degree of microporosity. The high degree of microporosity of activated carbon imparts sorptive properties. In the additional embodiment of the invention, the absorbent clay comprises 50.0 to 100% volume (v/v) of the absorbent formulation 220 while the activated carbon comprises 0.1 to 50.0% (v/v) of the absorbent formulation 220. The combination of absorbent clay and activated carbon was experimentally determined to increase absorption of ethylene gas as well as noticeably reduce unwanted odors.

In the additional embodiment of the invention, the activated carbon comprises a plurality of activated carbon pellets. The plurality of activated carbon pellets increase the surface area of the activated carbon resulting in a greater absorptive effect. In the aforementioned embodiment each pellet of the plurality of activated carbon pellets is approximately 4.0 mm in diameters. The 4.0 mm diameter size of each activated carbon pellet facilitates movement and placement of the absorbent pouch 200 within the interior chamber 120.

The invention is an apparatus for a humidity and odor controller for use with a refrigerator or food storage container. The odor and moisture controller comprises a cross-ventilated container and an absorbent pouch 200. The cross-ventilated container optimizes the airflow to the absorbent pouch 200. The absorbent pouch 200 comprises an all natural mineral compound that absorbs gases emitted by foods.

The odor and moisture controller is assembled by placing the absorbent pouch 200 inside the cross-ventilated container which is then sealed. The odor and moisture controller is placed in a refrigerator to achieve. Additionally, a second odor and moisture controller can be placed in the freezer portion of the refrigerator in order to maximize absorption. It is estimated that the odor and moisture controller should be replaced once every 6 months.

The odor and moisture controller removes ethylene gas, controls odors, and reduces humidity. The odor and moisture controller is particularly suited for removing ethylene gas. Ethylene gas accelerates the ripening or decaying process of fruits and vegetables. By minimizing the presence of ethylene gas within a refrigerator or food storage container, food spoilage which leads to unpleasant odors, can be slowed or significantly halted. Through the retardation of spoilage, fruits and vegetables are able to be kept fresh for a longer period of time. Additionally, the reduction of unpleasant odors within a refrigerator or food storage container reduces the likelihood of unwanted flavors to permeate into different foods. Additionally, the odor and moisture controller regulates humidity within a refrigerator or food storage container. By mitigating the humidity within a refrigerator or food storage container, the odor and moisture controller reduces the energy required to cool said refrigerator or food storage container.

Although the invention has been explained in relation to its preferred embodiment, it is to be understood that many other possible modifications and variations can be made without departing from the spirit and scope of the invention as hereinafter claimed.

What is claimed is:

1. A odor and moisture controller comprises:
an enclosure;
an absorbent pouch;
the enclosure comprises outer walls, an interior chamber, at least one opening, and a plurality of vents;
the absorbent pouch comprises a permeable exterior and an absorbent formulation;
the absorbent formulation comprises an absorbent clay;
the interior chamber being surrounded by the outer walls;
the interior chamber being enclosable by way of the at least one opening;
the plurality of vents traverse through the outer walls into the interior chamber;
the pouch being removeably positioned within the interior chamber by way of the at least one opening; and
the absorptive formulation being surrounded by the permeable exterior.

2. The absorbent clay as claimed in claim 1 comprises at least one naturally active mineral selected from a group consisting of Palygorskite, Sepiolite, Montmorillonite, Beidellite, and Kaolinite.

3. The absorbent clay as claimed in claim 1 comprises a plurality of absorbent clay pellets sized approximately at 4.0 mm in diameter.

4. The absorbent formulation as claimed in claim 1 comprises activated carbon.

5. The absorbent clay as claimed in claim 4 being found ranging between 50.0 to 100% (v/v) of the absorbent formulation.

6. The activated carbon as claimed in claim 4 being found ranging between 0.1 to 50.0% (v/v) of the absorbent formulation.

7. The activated carbon as claimed in claim 4 comprises a plurality of activated carbon pellets sized approximately at 4.0 mm in diameter.

8. A odor and moisture controller comprises:
an enclosure;
an absorbent pouch;
the enclosure comprises outer walls, an interior chamber, at least one opening, and a plurality of vents;
the absorbent pouch comprises a permeable exterior and an absorbent formulation;
the absorbent formulation comprises an absorbent clay and activated carbon;
the interior chamber being surrounded by the outer walls;
the interior chamber being enclosable by way of the at least one opening;
the plurality of vents traverse through the outer walls into the interior chamber;
the pouch being removeably positioned within the interior chamber by way of the at least one opening;
the absorptive formulation being surrounded by the permeable exterior;
the absorbent clay being found ranging between 50.0 to 100% (v/v) of the absorbent formulation; and
the activated carbon being found ranging between 0.1 to 50.0% (v/v) of the absorbent formulation.

9. The absorbent clay as claimed in claim 8 comprises at least one naturally active mineral selected from a group consisting of Palygorskite, Sepiolite, Montmorillonite, Beidellite, and Kaolinite.

10. The absorbent clay as claimed in claim 8 comprises a plurality of absorbent clay pellets sized approximately at 4.0 mm in diameter.

11. The activated carbon as claimed in claim 8 comprises a plurality of activated carbon pellets sized approximately at 4.0 mm in diameter.

12. A odor and moisture controller comprises:
an enclosure;
an absorbent pouch;
the enclosure comprises outer walls, an interior chamber, at least one opening, and a plurality of vents;
the absorbent pouch comprises a permeable exterior and an absorbent formulation;
the absorbent formulation comprises an absorbent clay and activated carbon;
the interior chamber being surrounded by the outer walls;
the interior chamber being enclosable by way of the at least one opening;
the plurality of vents traverse through the outer walls into the interior chamber;
the pouch being removeably positioned within the interior chamber by way of the at least one opening;
the absorptive formulation being surrounded by the permeable exterior;
the absorbent clay being found ranging between 50.0 to 100% (v/v) of the absorbent formulation;
the activated carbon being found ranging between 0.1 to 50.0% (v/v) of the absorbent formulation;
the absorbent clay comprises a plurality of absorbent clay pellets sized approximately at 4.0 mm in diameter;
the activated carbon comprises a plurality of activated carbon pellets sized approximately at 4.0 mm in diameter;

13. The absorbent clay as claimed in claim 12 comprises at least one naturally active mineral selected from a group consisting of Palygorskite, Sepiolite, Montmorillonite, Beidellite, and Kaolinite.
